(19) United States
(12) Patent Application Publication
(10) Pub. No.: US 2002/0167492 A1
(43) Pub. Date: Nov. 14, 2002

(54) Pointing device with an extensible cord

(76) Inventors: Chin-Kuan Lou, Taipei City (TW); Yu-Chih Cheng, Taipei City (TW); Chai Chung, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 09/851,567

(22) Filed: May 10, 2001

(51) Int. Cl. G09G 5/08

(52) U.S. Cl. 345/163

(57) ABSTRACT

A pointing device includes a housing, a sensing circuit disposed within the housing for generating the pointing signals, a cable electrically connected to the sensing circuit for transmitting the pointing signals to the external device, and a reeling device disposed within the housing for reeling in or reeling our the cable. The reeling device is used to reel in excess portions of the cable outside of the housing, or to reel out additional portions of the cable within the housing.

### BACKGROUND OF THE INVENTION

1. Field of the Invention

The present invention relates to a pointing device, and more particularly, to a pointing device with an extensible cord.

2. Description of the Prior Art

Pointing devices are indispensable PC peripherals. Standard pointing devices generally have a cable that electrically connects to a computer. The length of the cable is frequently longer than required by the user, and sometimes the excess portions of the cable will become tangled, restricting the pointing device and inconveniencing the user.

Please refer to FIG. 1. FIG. 1 is a perspective view of a prior art pointing device 30. As shown in FIG. 1, the pointing device 30 is a typical mouse 30. The mouse 30 has a cable 32 to electrically connect to a computer 10. There may be several articles near the computer 10 in an office or home environment, such as a cup 20. The cable 32 of the mouse 30 is much longer than required, and so it often loops. These loops may snag on some article, such as the cup 20. When this happens, the user must untangle the cable 32 to restore the full range of motion of the mouse 30. Managing the excess portions of the cable 32 is thus a useful idea.

### SUMMARY OF THE INVENTION

It is therefore a primary objective of the present invention to provide a pointing device with an extensible cord to solve the above-mentioned problem.

According to claimed invention, the pointing device is adapted to provide pointing signals to an external device, such as a computer. The pointing device includes a housing, a sensing circuit disposed within the housing for generating the pointing signals, a cable electrically connected to the sensing circuit for transmitting the pointing signals to the external device, and a reeling device disposed within the housing for reeling in or reeling out the cable. The reeling device is used to reel in excess portions of the cable outside of the housing, and to reel out additional portions of the cable within the housing.

It is an advantage of the present invention that the reeling device enables a user to control the external length of the cable, and thus to minimize the chances of the unwanted cable lengths becoming entangled.

These and other objectives and advantages of the present invention will no doubt become obvious to those of ordinary skill in the art after having read the following detailed description of the preferred embodiment that is illustrated in the various figures and drawings.

### BRIEF DESCRIPTION IF THE DRAWINGS

FIG. 1 is a perspective view a prior art pointing device.

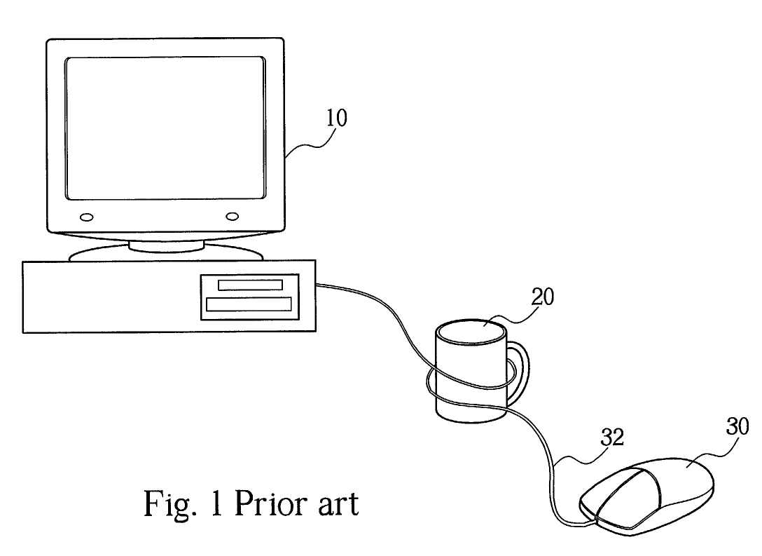

FIG. 2 is a block diagram of a present invention pointing device.

FIG. 3 is a diagram of a first preferred embodiment of the present invention pointing device.

FIG. 4 is a diagram of a second preferred embodiment of the present invention pointing device.

FIG. 5 is a diagram of a bottom view of the present invention pointing device shown in FIG. 3.

FIG. 6 is a diagram of a bottom view of another preferred embodiment of the present invention pointing device.

### DETAILED DESCRIPTON OF THE PREFERRED EMBODIMENT

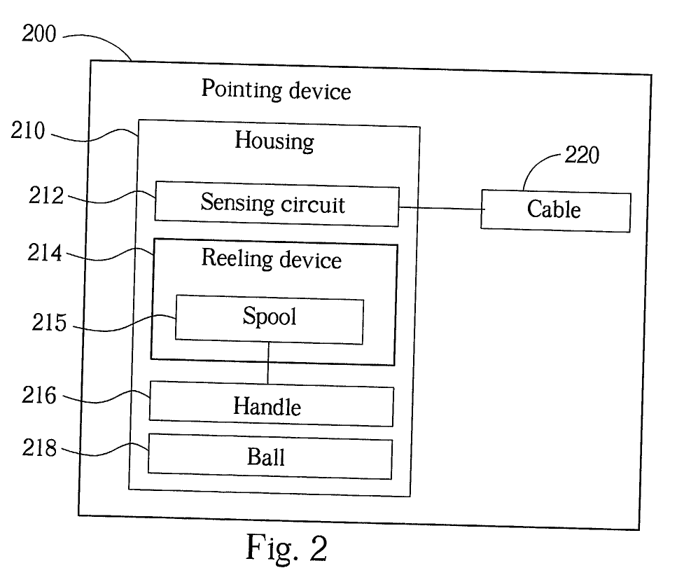

Please refer to FIG. 2. FIG. 2 is a block diagram of a present invention pointing device 200. The present invention pointing device 200 is used to provide pointing signals to an external device, such as a computer. The pointing device 200 comprises a housing 210, a sensing circuit 212 disposed within the housing 210 for generating the pointing signals by sensing the rotation of a ball 218, a cable 220 electrically connected to the sensing circuit 212 for transmitting the pointing signals to the external device, and a reeling device 214 disposed within the housing 210 for reeling in or reeling out the cable 220.

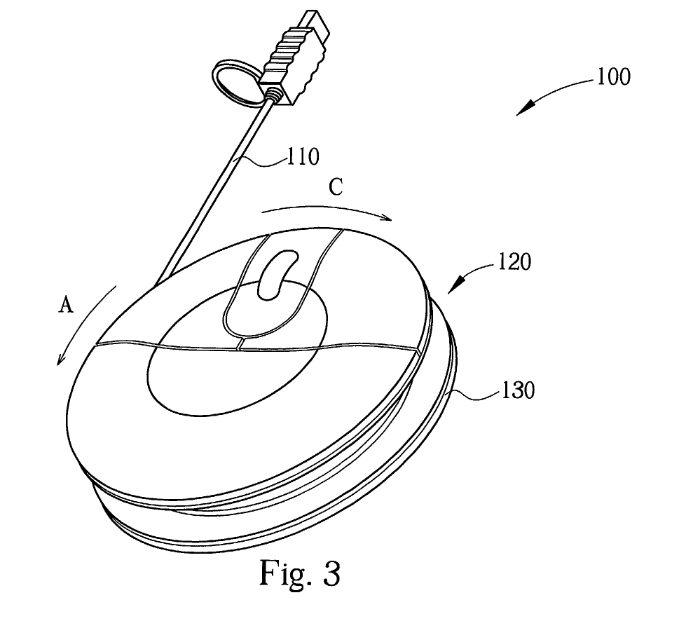

Please refer to FIG. 3. FIG. 3 is a diagram of a first preferred embodiment of the present invention pointing device 100. The pointing device 100 is a mouse 100. The reeling device 130 of the mouse 100 is used to reel in excess portions of the cable 110 outside of the housing 120 by rotating along a direction A (anti-clockwise). The reeling device 130 of the mouse 100 is also used to reel out additional portions of the cable 110 within the housing 120 by rotating along a direction C (clockwise).

Please refer back to FIG. 2. The reeling device 214 of the pointing device 200 comprises a spool 215 rotatably disposed within the housing 210 for reeling in or reeling out the cable 220. Additionally, the pointing device 200 also comprises a handle 216 mechanically connected to the spool 215. The handle 216 enables a user to rotate the spool in a first direction to reel in the cable 220 (i.e., the direction A in FIG. 3) or to rotate the spool in a second direction to reel out the cable 220 (i.e., the direction C in FIG. 3).

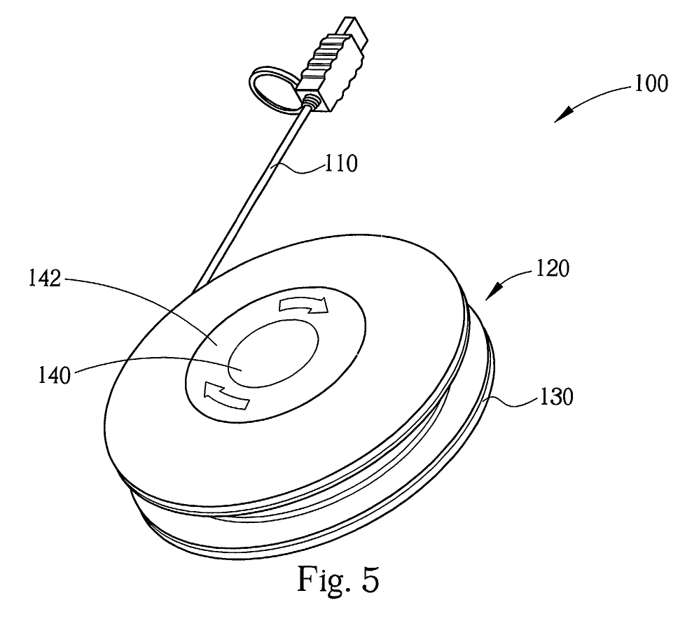

Please refer to FIG. 5 with FIG. 3. FIG. 5 is a diagram of a bottom view of the present invention pointing device 100 shown in FIG. 3. The pointing device 100 further comprises a ball 140 rotatably disposed within the housing 120, and the sensing circuit (212 of FIG. 2) senses rotations of the ball 140 to generate the pointing signals. Furthermore, the ball 140 of the pointing device 100 is rotatably disposed wherein a hollow central portion of the spool (215 of FIG. 2). The bottom of the pointing device 100 has an access port 142 disposed in the housing 120 for securing the ball 140 within the housing 120. The access port 142 can be opened, and the ball 140 can be taken out for cleaning if the ball 140 is dirty.

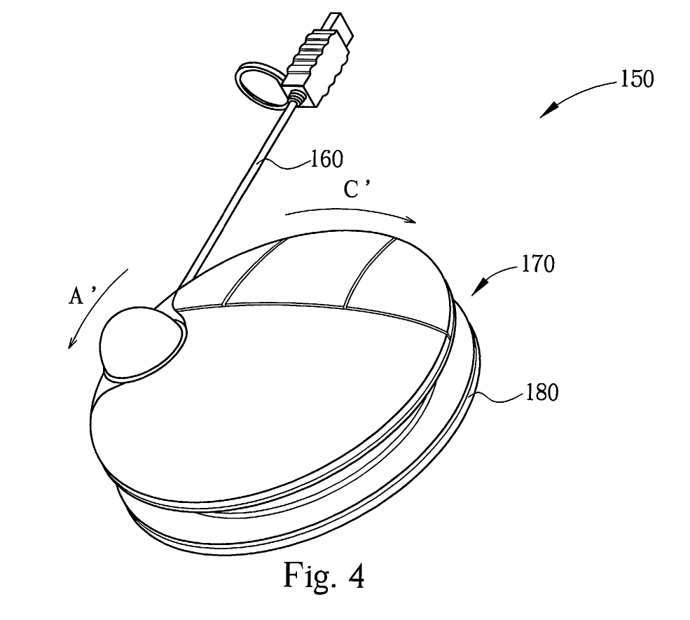

Please refer to FIG. 4. FIG. 4 is a diagram of a second preferred embodiment of the present invention, a pointing device 150. The pointing device 150 is a track ball 150. The structure of the reeling device 180 of the track ball 150 is similar to the structure of the reeling device 130 of the mouse 100 shown in FIG. 3. The reeling device 180 of the track ball 150 is used to reel in excess portions of the cable 160 outside of the housing 170 along a direction A′ (anti-clockwise). The reeling device 180 of the track ball 150 is also used to reel out additional portions of the cable 160 within the housing 170 along a direction C′ (clockwise).

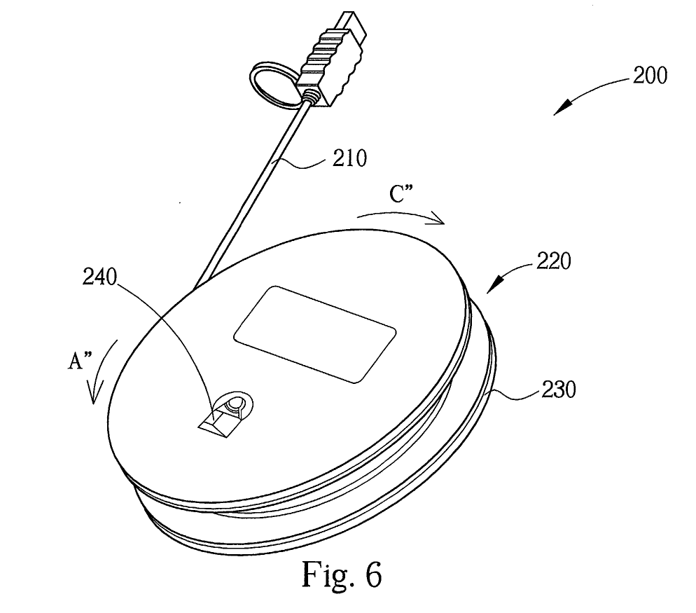

Please refer to FIG. 6. FIG. 6 is a diagram of a bottom view of another preferred embodiment of the present invention pointing device 200. The pointing device 200 is an optical mouse 200. The optical mouse 200 has a housing 220 with an opening 240. It is through the opening 240 that the optical mouse 200 “sees” the surface on which the optical mouse 200 slides. Displacement information is sent to a computer (not shown) by way of a cable 210. The cable 210 may end in one of many standard adapters, such as a PS/2 adapter, a universal serial bus (USB) adapter, etc.

The optical mouse 200 also has a structure of a reeling device 230 which is similar with the structure of the reeling device 180 of the track ball 150 and the structure of the reeling device 130 of the mouse 100. The reeling device 230 of the optical mouse 200 is used to reel in excess portions of the cable 210 outside of the housing 220 along a direction A″ (anti-clockwise). The reeling device 230 of the optical mouse 200 is also used to reel out additional portions of the cable 210 within the housing 220 along a direction C″ (clockwise).

In the contrast to the prior art, the present invention pointing device 10 enables a user to reel in excess portions of a cable outside of a housing of the pointing device. The user may also reel out additional portions of the cable within the housing.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A pointing device adapted to provide pointing signals to an external device, the pointing device comprising:
a housing;
a sensing circuit disposed within the housing for generating the pointing signals;
a cable electrically connected to the sensing circuit for transmitting the pointing signals to the external device; and
a reeling device disposed within the housing for reeling in or reeling out the cable;
wherein the reeling device is used to reel in excess portions of the cable outside of the housing, or the reeling device is used to reel out additional portions of the cable within the housing.

2. The pointing device of claim 1 wherein the reeling device comprises a spool rotatably disposed within the housing for reeling in or reeling out the cable.

3. The pointing device of claim 2 further comprising a ball rotatably disposed within the housing, and the sensing circuit senses rotations of the ball to generate the pointing signals.

4. The pointing device of claim 3 wherein the ball is rotatably disposed within a hollow central portion of the spool.

5. The pointing device of claim 2 further comprising a handle mechanically connected to the spool, the handle enabling a user to rotate the spool in a first direction to reel in the cable, or to rotate the spool in a second direction to reel out the cable.

6. The pointing device of claim 3 wherein the pointing device is a mouse.

7. The pointing device of claim 3 wherein the pointing device is a track ball.
